(19) United States
(12) Patent Application Publication
(10) Pub. No.: US 2026/0225167 A1
(43) Pub. Date: Aug. 6, 2026

(54) SAW SYSTEM

(71) Applicant: The M.K. Morse Company, Canton, OH (US)

(72) Inventors: Roan Kirwin, Canton, OH (US); Mark Taylor, Marietta, GA (US); Seth Ramsey, Navarre, OH (US)

(21) Appl. No.: 19/159,072

(22) PCT Filed: Feb. 22, 2024
(86) PCT No.: PCT/US2024/016792

§ 371 Date: Aug. 22, 2025

Related U.S. Application Data
(60) Provisional application No. 63/447,712, filed on Feb. 23, 2023.
(60) Provisional application No. 63/598,123, filed on Nov. 12, 2023.

(51) Int. Cl. B23D 55/06; B23D 59/00

(52) U.S. Cl. CPC B23D 55/06; B23D 59/001; B23D 59/006

(57) ABSTRACT

A saw system can include a cutter head assembly, a saw bed, and at least one radar sensor. The cutter head assembly can include a frame, at least one drive motor, a first pulley, at least one rotary driver, a second pulley, a saw blade, and a controller. The first pulley and the at least one rotary driver can be driven in rotation by the at least one drive motor. The controller can be configured to control the at least one drive motor. The saw bed can support a workpiece. The at least one radar sensor can determine the relative velocity between the cutter head assembly and the saw bed and transmit the relative velocity or raw data indicating the relative velocity to the controller. The controller can control the at least one drive motor in response to the relative velocity and/or the raw data received from the at least one radar sensor.

### CROSS-REFERENCE TO RELATED APPLICATIONS

This application claims the priority benefit of U.S. Provisional Patent Application Ser. No. 63/447,712 for a CUTTING PROCESS WITH SENSOR INPUT, filed on Feb. 23, 2023, which is hereby incorporated by reference in its entirety. This application also claims the priority benefit of U.S. Provisional Patent Application Ser. No. 63/598,123 for a Saw Monitoring System, filed on Nov. 12, 2023, which is hereby incorporated by reference in its entirety.

### BACKGROUND

### 1. Field

The present disclosure relates to saw systems used for cutting workpieces. 2. Description of Related Prior Art

U.S. Pub. No. 2015/0277431A1 discloses a Saw data acquisition system and method of operating a saw. The saw data acquisition system and method of operating a saw employ sensors that detect specific data regarding a cutting operation. The system and method enable the saw operator to input data and display selected the data for the operator. Data that is detected by the sensors and which is input are collected and transmitted to a central processing location, acquired at the central processing location, and analyzed. The analysis enables optimum cutting parameters for a given cutting task, guidance regarding optimum operation and efficiency of the saw, information for improved blade design and manufacture, and optional remote monitoring capabilities of multiple saws, to be provided.

The background description provided herein is for the purpose of generally presenting background context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

This section provides a simplified summary in order to provide a basic understanding of some aspects described herein. This summary is not an extensive overview and is not intended to identify “key” or “critical” elements of the present disclosure or to delineate the scope of the various aspects described herein. The purpose of this portion of the document is to present some concepts in a simplified form as a prelude to the more detailed description that is presented later.

A saw system can include a cutter head assembly, a saw bed, and at least one radar sensor. The cutter head assembly can include a frame, at least one drive motor, a first pulley, at least one rotary driver, a second pulley, a saw blade, and a controller. The at least one drive motor can be mounted on the frame. The first pulley can be mounted for rotation on the frame and can be operably engaged with the at least one drive motor whereby the first pulley is driven in rotation by the at least one drive motor. The at least one rotary driver can be mounted for rotation on the frame and can be operably engaged with the at least one drive motor whereby the rotary driver is driven in rotation by the at least one drive motor. The second pulley can be mounted for rotation on the frame and spaced from the first pulley. The saw blade can extend around the first pulley and the second pulley. The controller can be configured to control operations of the at least one drive motor. The saw bed can be configured to support a workpiece to be cut during a cutting operation performed by the cutter head assembly. The at least one radar sensor can be mounted to one of the cutter head assembly and the saw bed. The at least one radar sensor can be configured to emit radio waves in a direction of the other of the cutter head assembly and the saw bed. The at least one radar sensor can be configured to receive radio waves previously emitted by the at least one radar sensor and deflected by the other of the cutter head assembly and the saw bed. The at least one radar sensor can be configured to one of (i) determine a relative velocity between the cutter head assembly and the saw bed based on received radio waves and transmit the relative velocity to the controller and (ii) transmit raw data associated with received radio waves to the controller. The controller can be further defined as configured to control operations of the at least one drive motor in response to the one of the relative velocity and the raw data received from the at least one radar sensor.

According to other features, the at least one radar sensor can be further defined as pivotally mounted on the cutter head assembly and freely pivotable in response to gravity. The at least one radar sensor can be further defined as mounted to the frame with one or more magnets and configured to communicate with the controller wirelessly.

In other features, the saw system can also include a blade velocity sensor and a pulley angular speed sensor. The blade velocity sensor can be directed at the saw blade and can be configured to detect a velocity of the saw blade and transmit the detected velocity of the saw blade to the controller. The pulley angular speed sensor can be directed at one of the first pulley and the second pulley. The pulley angular speed sensor can be configured to detect an angular speed of the one of the first pulley and the second pulley and can transmit the detected angular speed of the one of the first pulley and the second pulley to the controller. The controller can be configured to determine a consistency between the detected velocity of the saw blade and the detected angular speed of the one of the first pulley and the second pulley.

According to additional features, the saw system can also include a band proximity sensor that can be directed at the saw blade and can be configured to detect proximity of the saw blade and transmit the detected proximity of the saw blade to the controller. The saw system can also include at least one guide arm that can support the saw blade and a vibration sensor that can be directed at the at least one guide arm. The vibration sensor can be configured to detect vibration of the at least one guide arm and transmit the detected vibration to the controller.

According to other features, the saw system can also include a chip brush assembly and a rotation sensor. The chip brush assembly can be mounted on the frame and can be positioned adjacent to the saw blade. The chip brush assembly can have a shaft and a brush mounted on the shaft. The shaft can rotate as the brush engages the saw blade as the saw blade moves during the cutting operation. The rotation sensor can be operably engaged with the shaft of the chip brush assembly and can be configured to detect rotation of the shaft of the chip brush assembly and transmit the detected rotation of the shaft of the chip brush assembly to the controller.

In other features, the saw system can also include a current sensor that can be disposed to sense current passing through at least part of the at least one drive motor and transmit a level of the current to the controller. The saw blade can also include an identifier and the saw system can also include an identification sensor that can be directed at the saw blade and can be configured to the identifier and transmit the detected identifier of the saw blade to the controller.

According to additional features, the saw system can also include a cut depth sensor assembly. The cut depth sensor assembly can include a rod, a collar, and a movement sensor. The rod includes a first end configured to rest on the workpiece during the cutting operation, wherein the collar is fixedly positioned relative to the cutter head assembly and includes an aperture, wherein the rod is received in the aperture and moves in the aperture as the cutter head assembly moves relative to the saw bed during the cutting operation, and wherein the movement sensor is fixedly positioned relative to the cutter head assembly and positioned to sense movement of the rod relative to collar and transmit signals corresponding to sensed conditions to the controller.

According to other features, the saw system can also include a track on which the frame can be mounted for movement and a cutter head drive sensor that can be configured to sense an extent of the movement of the frame relative to the track and transmit signals corresponding to sensed conditions to the controller.

A method of cutting a workpiece can include supporting a workpiece on a saw bed. The method can also include rotating a band saw blade of a cutter head assembly. The method can also include moving one of the cutter head assembly and the saw bed relative to the other during the rotating and the supporting whereby the band saw blade can be directed through the workpiece. The method can also include monitoring a relative velocity between a portion of the saw bed and a portion of the cutter head assembly during the moving with radar.

In other features, the moving step can be further defined as pivoting the cutter head assembly about a pivot axis, wherein the saw bed can be stationary during the moving. The method can also include reading, with an identification reader, identification data associated with the band saw blade wherein the data is fixedly associated with the band saw blade. The method can also include fetching, with a controller, specification data associated with the band saw blade from a database in response to the identification data read during the reading. The method can also include receiving, with the controller, workpiece data being at least one of material, cross-sectional shape, and size of the workpiece. The method can also include determining, with the controller, at least one parameter of movement during the rotating and the moving in response to the specification data and the workpiece data.

According to additional features, the method can also include updating, with the controller, usage data associated with the band saw blade stored in the database after the moving. The method can also include sensing at least one parameter of movement during the rotating and the moving with a sensor. The method can also include transmitting, with the sensor, sensed data associated with the at least one parameter of movement to a controller. The method can also include displaying, on a video monitor screen controlled by the controller, the transmitted data associated with the at least one parameter.

According to other features, the transmitting can be further defined as transmitting wirelessly, with the sensor, sensed data associated with the at least one parameter of movement to the controller. The method can also include determining, with the controller, in response to the transmitted data associated with the at least one parameter, a change in the at least one parameter of movement. The method can also include displaying, on a video monitor screen controlled by the controller, the change in the at least one parameter.

### BRIEF DESCRIPTION OF THE DRAWINGS

The detailed description set forth below references the following drawings:

FIG. 1 is a schematic, generally front view of a saw system according to an embodiment of the present disclosure;

FIG. 2 is a schematic, right side, and partial cross-sectional view, taken along section lines 2-2 in FIG. 1;

FIG. 3 is a schematic, downward, and partial cross-sectional view, taken along section lines 3-3 in FIG. 1;

FIG. 4 is a schematic view of the data/electrical signal communication capacity between components of the exemplary system utilized for monitoring and control of the saw system shown in FIG. 1;

FIG. 5 is a schematic representation of a portion of the exemplary saw system configured for and disposed to communicate with other computing devices;

FIG. 6 is a first isometric/perspective view of a mount configured to mount a sensor or other structure as part of the saw system;

FIG. 7 is a second perspective view of the mount shown in FIG. 6;

FIG. 8 is a third perspective view of the mount shown in FIGS. 6 and 7;

FIG. 9 is a perspective view of another embodiment of a saw system according to the present disclosure;

FIG. 10 is a simplified flow diagram of radar processing in one or more embodiments of the present disclosure; and

FIG. 11 is a schematic front view of a saw system according to another embodiment of the present disclosure.

### DETAILED DESCRIPTION

A plurality of different embodiments of the present disclosure is shown in the Figures of the application. Similar features are shown in the various embodiments of the present disclosure. Similar features across different embodiments have been numbered with a common reference numeral and have been differentiated by an alphabetic suffix. Also, to enhance consistency, the structures in any particular drawing share the same alphabetic suffix even if a particular feature is shown in less than all embodiments. Similar features are structured similarly, operate similarly, and/or have the same function unless otherwise indicated by the drawings or this specification. Furthermore, particular features of one embodiment can replace corresponding features in another embodiment or can supplement other embodiments unless otherwise indicated by the drawings or this specification.

The present disclosure, as demonstrated by the exemplary embodiment described below, can provide a system for cutting workpieces. Exemplary systems are disclosed that can execute the cutting of workpieces while enhancing the efficient use and management of saw blades. The exemplary system can monitor and record the use of saw blades and assist the operators of such systems to utilize the saw blades at higher efficiency over existing systems.

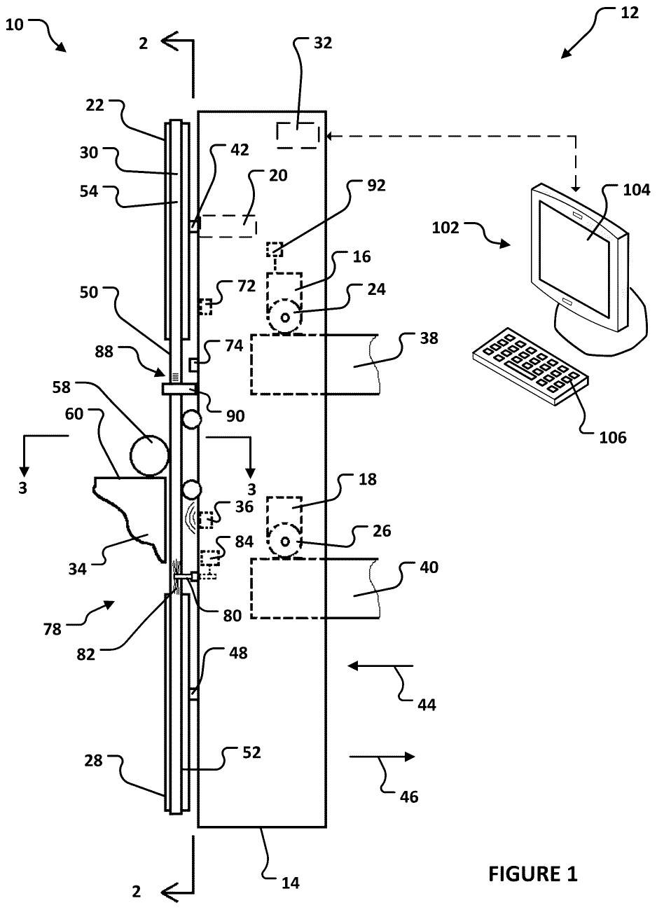

Referring now to FIGS. 1-3, an exemplary saw system 10 includes an exemplary cutter head assembly 12. The exemplary cutter head assembly 12 includes an exemplary frame 14. The exemplary frame 14 is shown schematically. An exemplary frame utilized in one or more embodiments of the present disclosure can be housing-like, wherein some or most or all the other components of the cutter head assembly are mounted within the housing-like frame. An exemplary frame utilized in one or more other embodiments of the present disclosure can be skeletal-like, wherein the other components of the cutter head assembly are mounted on, directly or indirectly, beams of a skeletal-like frame. In other embodiments of the present disclosure, a frame can include both housing-like and skeletal-like portions.

The exemplary cutter head assembly 12 also includes at least one drive motor. In the exemplary embodiment, the cutter head assembly 12 includes a plurality of drive motors 16, 18, 20. The operation of each of the exemplary drive motors 16, 18, 20 will be set forth in greater detail below. The exemplary drive motors 16, 18, 20 are mounted on the exemplary frame 14.

In one or more embodiments of the present disclosure, a cutter head assembly could include a single drive motor and a plurality of transmissions. Each transmission could be configured to transmit power (such as defined by rotation) to one or more other components of the cutter head assembly. The exemplary cutter head assembly 12 includes the drive motors 16, 18, 20 and can also include respective transmissions, one associated with each of the drive motors 16, 18, 20. The exemplary first drive motor 16 and associated transmission is positioned for driving the exemplary frame 14 along a track 38 on which the exemplary frame 14 is mounted for motion. The exemplary second drive motor 18 and associated transmission is positioned for driving the exemplary frame 14 along a track 40 on which the exemplary frame 14 is mounted for motion.

The exemplary cutter head assembly 12 also includes an exemplary first pulley 22. The exemplary first pulley 22 is mounted for rotation on the exemplary frame 14. The exemplary first pulley 22 is driven in rotation by the third drive motor 20. In the exemplary embodiment, the exemplary cutter head assembly 12 includes a first shaft 42 fixed to the exemplary first pulley 22 and the third drive motor 20 drives the first shaft 42 in rotation to rotate the exemplary first pulley 22.

The exemplary cutter head assembly 12 also includes at least one rotary driver mounted for rotation on the exemplary frame 14 and operably engaged with the at least one drive motor whereby the rotary driver is driven in rotation by the at least one drive motor. Further, the at least one rotary driver is configured to convert rotation generated by the at least one drive motor into movement of the exemplary cutter head assembly 12, rectilinear and/or pivoting movement. The exemplary embodiment includes a first rotary driver 24 and a second rotary driver 26. Each of the exemplary first rotary driver 24 and exemplary second rotary driver 26 is a wheel. The exemplary first rotary driver 24 is driven in rotation by the first drive motor 16 and the exemplary second rotary driver 26 is driven in rotation by the second drive motor 18. Rotation of the drivers 24, 26 results in movement of the cutter head assembly 12 along the tracks 38, 40. In other embodiments of the present disclosure, a rotary driver could take the form of a worm, a gear, a shaft, or some other structure that can be utilized to convert rotation that is generated by the drive motors 16, 18 into rectilinear or pivoting motion of the cutter head assembly.

The exemplary cutter head assembly 12 moves rectilinearly relative to the exemplary saw bed 34 along the tracks 38, 40 during a cutting operation. The exemplary first rotary driver 24 is driven in rotation by the first drive motor 16 along the first track 38, back and forth, along a cutting direction axis. Similarly, the exemplary second rotary driver 26 is driven in rotation by the second drive motor 18 along the second track 40, back and forth, along the cutting direction axis. The direction of motion during the cutting operation, into the workpiece, is referenced at 44 in FIG. 1. The direction of motion after the cutting operation, withdrawing from the workpiece, is referenced at 46 in FIG. 1. It is noted that, in one or more embodiments of the present disclosure, the motion of the cutter head into a workpiece can be accomplished using gravity and such an embodiment could include components to slow the rate of descent as desired.

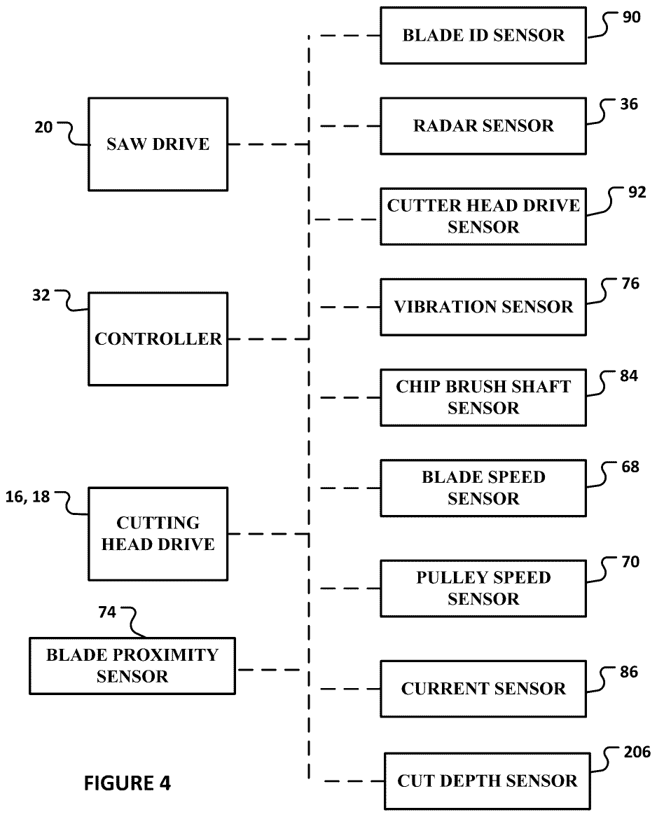

The saw system 10 can also include at least one cutter head drive sensor. The exemplary saw system 10 includes an exemplary cutter head drive sensor 92, shown schematically in FIGS. 1 and 4. The exemplary first cutter head drive sensor 92 is configured to sense the extent of the movement of the exemplary frame 14 relative to the exemplary track 38. This data indirectly corresponds to the instantaneous depth of the cut during the cutting operation. The exemplary first cutter head drive sensor 92 can be positioned to sense an attribute of the motor 16, such as the number of rotations of an output shaft of the motor 16 and correlate that variable to the distance travelled by the cutter head assembly 12 along the track 38. Alternatively, the exemplary first cutter head drive sensor 92 can sense the motion of the rotary driver 24, which also corresponds to the extent of the movement of the exemplary frame 14 relative to the track 38.

The exemplary cutter head assembly 12 also includes an exemplary second pulley 28 mounted for rotation on the exemplary frame 14. The exemplary second pulley 28 is spaced from the exemplary first pulley 22. In the exemplary embodiment, the exemplary cutter head assembly 12 includes a second shaft 48 fixed to the exemplary second pulley 28. The exemplary second pulley 28 and second shaft 48 can be engaged with the exemplary frame 14 for free rotation.

The exemplary cutter head assembly 12 also includes an exemplary saw blade 30. The exemplary saw blade 30 extends around the exemplary first pulley 22 and the exemplary second pulley 28. The exemplary saw blade 30 is an endless loop or ribbon. The exemplary saw blade 30 defines a front face 50 having a plurality of teeth and a back face 52 that is opposite of the front face 50. The exemplary back face 52 can be flat or partially flat. The exemplary saw blade 30 also includes first and second side faces 54, 56 that each extend between the exemplary front face 50 and exemplary back face 52.

The exemplary cutter head assembly 12 also includes an exemplary controller 32. The exemplary controller 32 is configured to control operations of the drive motors 16, 18, 20. In various embodiments of the present disclosure, the exemplary controller 32 may be defined by a computer, computer system, controller, logic controller, other programmable electronic device or any combination thereof, and may in some embodiments be implemented using one or more networked computers or other electronic devices, whether located locally or remotely with respect to the other components of the saw system 10. The exemplary controller 32 typically includes a central processing unit (CPU) including at least one microprocessor coupled to a memory, which may represent the random access memory (RAM) devices comprising the main storage of the exemplary controller 32, as well as any supplemental levels of memory, e.g., cache memories, non-volatile or backup memories (e.g., programmable or flash memories), read-only memories, etc. In addition, the memory may be considered to include memory storage physically located elsewhere in the exemplary controller 32, e.g., any cache memory in a processor in CPU, as well as any storage capacity used as a virtual memory, e.g., as stored on a mass storage device or on another computer or electronic device coupled to the exemplary controller 32. The exemplary controller 32 may also include one or more mass storage devices, e.g., a floppy or other removable disk drive, a hard disk drive, a direct access storage device (DASD), an optical drive (e.g., a CD drive, a DVD drive, etc.), and/or a tape drive, among others. Furthermore, the exemplary controller 32 may include an interface with one or more networks (e.g., a LAN, a WAN, a wireless network, and/or the Internet, among others) to permit the communication of information to the components of the saw system 10 as well as with other computers and electronic devices. The exemplary controller 32 operates under the control of an operating system, kernel and/or firmware and executes or otherwise relies upon various computer software applications, components, programs, objects, modules, data structures, etc. Moreover, various applications, components, programs, objects, modules, etc. may also execute on one or more processors in another computer coupled to the exemplary controller 32, e.g., in a distributed or client-server computing environment, whereby the processing required to implement the functions of a computer program may be allocated to multiple computers over a network. In the exemplary embodiment of the present disclosure, the controller 32 includes a Raspberry Pi CM4 Board that has a Broadcom BCM2711, quad core Cortex-A72 (ARM v8) 64-bit SoC @ 1.5 GHz. The exemplary controller 32 can be mounted on the exemplary saw bed 34 or the exemplary cutter head assembly 12 in various embodiments of the present disclosure.

The exemplary first cutter head drive sensor 92 can transmit signals corresponding to sensed conditions to the exemplary controller 32. The exemplary controller 32 can control operations of the drive motors 16, 18, 20 in response to signals received from the exemplary cutter head drive sensor 92. For example, the exemplary controller 32 can stop the operation of the drive motors 16, 18 if the data indicates that the exemplary cutter head assembly 12 has moved as far as necessary to complete the desired cut.

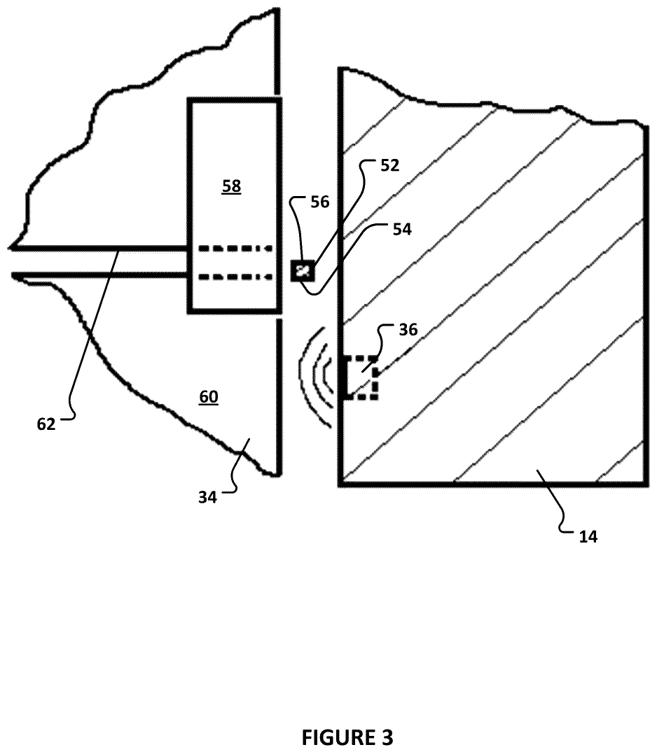

The exemplary saw system 10 also includes an exemplary saw bed 34. The exemplary saw bed 34 configured to support a workpiece 58 to be cut during a cutting operation performed by the exemplary cutter head assembly 12. The exemplary saw bed 34 includes a workpiece supporting surface 60 on which the workpiece 58 rests during the cutting operation. As best shown in FIG. 3, the exemplary saw bed 34 also includes a slot 62 that receives the exemplary saw blade 30 so that the exemplary saw blade 30 can pass fully through the workpiece 58 during the cutting operation.

The exemplary saw system 10 also includes an exemplary radar sensor 36 mounted to one of the exemplary cutter head assembly 12 and the exemplary saw bed 34 and configured to emit radio waves in a direction toward the other of the exemplary cutter head assembly 12 and the exemplary saw bed 34. The exemplary radar sensor 36 can be mounted to the exemplary frame 14 with one or more magnets. The exemplary radar sensor 36 is configured to receive radio waves that were previously emitted by the exemplary radar sensor 36 and then deflected by the other of the exemplary cutter head assembly 12 and the exemplary saw bed 34. In the exemplary embodiment, the exemplary radar sensor 36 is mounted on the exemplary cutter head assembly 12, configured to emit radio waves in a direction toward the exemplary saw bed 34, and configured to receive radio waves that were previously emitted by the exemplary radar sensor 36 and then deflected by the exemplary saw bed 34.

The exemplary radar sensor 36 can be configured to determine a relative velocity between the exemplary cutter head assembly 12 and the exemplary saw bed 34 based on received radio waves and transmit the relative velocity to the exemplary controller 32. “Relative velocity” is the velocity at which the exemplary cutter head assembly 12 and the exemplary saw bed 34 are moving toward one another. In the exemplary embodiment, the exemplary cutter head assembly 12 is moved toward the exemplary saw bed 34, but embodiments of the present disclosure are not limited to this arrangement. The relative velocity is also the feed rate. The exemplary radar sensor 36 can include a sub-processor to determine the relative velocity between the exemplary cutter head assembly 12 and the exemplary saw bed 34 based on the data associated with the deflected radio waves that are received. Alternatively, or additionally, the exemplary radar sensor 36 can be configured to merely emit radio waves and collect deflected radio waves and then transmit the raw data associated with received, deflected radio waves to the exemplary controller 32, thereby allowing the exemplary controller 32 to calculate the relative velocity between the exemplary cutter head assembly 12 and the exemplary saw bed 34. In such an embodiment, the controller 32 can determine the relative velocity based on the raw data received from the exemplary radar sensor 36.

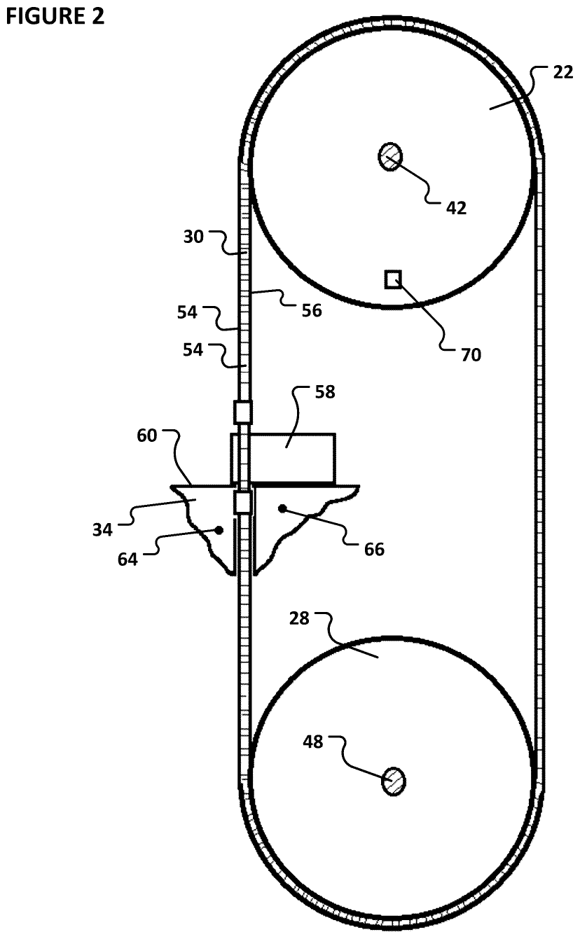

The exemplary radar sensor 36 can have a video display screen configured to display the relative velocity data and/or can send data over wire or wirelessly to the exemplary controller 32 for display to the operator. The exemplary radar sensor 36 is positioned on the exemplary cutter head assembly 12 and directs radio waves at the exemplary saw bed 34. The point referenced at number 64 in FIG. 2 is the exemplary center point on the exemplary saw bed 34 to which the waves emitted by the exemplary radar sensor 36 are directed. However, it is noted that the disclosure is not limited to such positioning or to such directional targeting. The point referenced at number 66 in FIG. 2 is an alternative exemplary point on the exemplary saw bed 34 to which the exemplary radar sensor 36 may be directed.

The exemplary controller 32 is configured to control the operations of the drive motors 16, 18, 20. The exemplary controller 32 can control the operation of the drive motors 16, 18 in response, at least in part, to the relative velocity and/or raw data received from the exemplary radar sensor 36. The relative velocity or raw data can be continuously received during a cutting operation, so that changes to the operation of the motors 16 and 18 can be made in real time. Further, the exemplary controller 32 can derive the distance between the cutter head assembly 12 and the saw bed 34 as well as acceleration data from the relative velocity data. For example, the exemplary controller 32 can slow the operation of the drive motors 16, 18 if the relative velocity or data indicates that the exemplary cutter head assembly 12 is moving too quickly toward the exemplary saw bed 34.

The exemplary saw system 10 also includes a blade velocity sensor 68 and a pulley angular speed sensor 70. The sensors 68, 70 are shown schematically in FIG. 4 and can be mounted as desired on the cutter head assembly 12. The exemplary blade velocity sensor 68 is directed at the exemplary saw blade 30 and configured to detect a velocity or “linear speed” of the exemplary saw blade 30; the linear speed is the velocity of the blade in a direction across the working piece. The exemplary blade velocity sensor 68 can apply any desired sensing protocol. For example, the exemplary blade velocity sensor 68 can be an inductive sensor with a magnet surrounded by a wire coil and produce an AC analog wave or a digital square wave. Such a sensor can sense or read the teeth of the saw blade 30 as they move past the exemplary blade velocity sensor 68 as the saw blade 30 spins around the pulleys 22, 28. The exemplary blade velocity sensor 68 can transmit the detected velocity of the exemplary saw blade 30 to the exemplary controller 32. The dashed lines in FIG. 4 represent the capacity for data communication between the represented components. It is noted that a cut sensor 206 is also shown in FIG. 4 and a detailed description of an embodiment of the cut sensor 206 is set forth below.

The pulley angular speed sensor 70 is also shown in FIG. 2 and can be directed at one of the exemplary first pulley 22 and the exemplary second pulley 28. In the exemplary embodiment, the pulley angular speed sensor 70 takes the form of an accelerometer and is directed at the exemplary first pulley 22 by being attached to the exemplary first pulley 22. The exemplary pulley angular speed sensor 70 is configured to detect an angular speed of the exemplary first pulley 22 and transmit the detected angular speed to the exemplary controller 32. The angular speed of the exemplary first pulley 22 corresponds to the linear speed of the band saw blade 30, based on a position of the sensor 70. In the exemplary embodiment, the exemplary pulley angular speed sensor 70 can transmit data to a transceiver 72 that is not mounted on the pulley 22 and the transceiver 72 transmits the detected angular speed to the exemplary controller 32.

The exemplary controller 32 can thus receive data from the exemplary blade velocity sensor 68 and from the exemplary pulley angular speed sensor 70. The exemplary controller 32 is configured to determine consistency between the velocity detected by the exemplary saw blade 30 and the angular speed detected by the pulley angular speed sensor 70. For example, if the exemplary controller 32 does not determine consistency the controller 32 can alert the operator and/or cease operations of the motors 16, 18, 20.

The exemplary saw system 10 can also include a band proximity sensor, referenced schematically at 74 in FIG. 1. The exemplary band proximity sensor 74 is directed at the exemplary saw blade 30. The exemplary band proximity sensor 74 is configured to detect proximity of the exemplary saw blade 30 and transmit the detected proximity of the exemplary saw blade 30 to the exemplary controller 32. The exemplary band proximity sensor 74 can be desirable to confirm that the saw blade 30 is mounted on the pulleys 22, 28. For example, the exemplary controller 32 can prevent the operation of the drive motors 16, 18, 20 from beginning if the exemplary saw blade 30 is not sensed.

The exemplary saw system 10 can also include a vibration sensor. The exemplary vibration sensor is directed at guide arms (not shown), which guide the saw blade 30 in motion. The exemplary vibration sensor is referenced schematically at 76 in FIG. 4. The exemplary vibration sensor 76 is configured to detect vibration of the guide arms and transmit the detected vibration to the exemplary controller 32. For example, the exemplary controller 32 can slow the operation of the drive motors 16, 18 if the data received from the exemplary vibration sensor 76 indicates that excessive vibration is occurring.

The exemplary saw system 10 also includes a chip brush assembly 78 mounted on the exemplary frame 14. The exemplary chip brush assembly 78 is positioned adjacent to the exemplary saw blade 30 and is configured to remove chips from the exemplary saw blade 30. The exemplary chip brush assembly 78 includes a shaft 80 and a brush 82 mounted on the shaft 80. The exemplary shaft 80 rotates as the brush 82 engages the exemplary saw blade 30, as the exemplary saw blade 30 moves during the cutting operation.

The exemplary saw system 10 also includes a rotation sensor 84 operably engaged with the shaft 80 of the exemplary chip brush assembly 78. The exemplary rotation sensor 84 is configured to detect rotation of the shaft 80 of the exemplary chip brush assembly 78. The exemplary rotation sensor 84 is configured to transmit the detected rotation of the shaft 80 of the exemplary chip brush assembly 78 to the exemplary controller 32. The exemplary controller 32 can control operations of the drive motors 16, 18, 20 in response to signals received from the exemplary rotation sensor 84. For example, the exemplary controller 32 can slow or stop the operation of the drive motors 16, 18, 20 if the data indicates that the exemplary brush 82 is not rotating.

The exemplary saw system 10 also includes a current sensor 86, shown schematically in FIG. 4. The exemplary current sensor 86 is disposed to sense current passing through at least one of the drive motors 16, 18, 20. The exemplary current sensor 86 is configured to transmit a level of the sensed/detected current to the exemplary controller 32. The exemplary controller 32 can control operations of the at least one of the drive motors 16, 18, 20 in response to signals received from the exemplary current sensor 86. For example, the exemplary controller 32 can slow the operation of the particular drive motor 16, 18, 20 if the current data indicates that the particular drive motor 16, 18, 20 is drawing an amount of current above a predetermined amount.

The exemplary saw blade 30 can also include an identifier. The exemplary identifier is referenced at 88 in FIG. 1 and is a bar code. Other forms of optic identifiers can be practiced in other embodiments of the present disclosure, such as quick response codes (two-dimensional bar codes). The bar code indicates the identity of the particular saw blade on which it is positioned. The identity of the saw blade can be utilized by the exemplary controller 32 to fetch data associated with that saw blade. By way of example and not limitation, the data associated with the saw blade can include usage history and recommended usage parameters. The exemplary identifier 88 can take the form of indicia printed, scored, or etched on, or stamped in the exemplary saw blade 30. The identifier 88 can thus be fixedly associated with the exemplary saw blade 30 and not be removed or damaged during a cutting operation. In one or more other embodiments of the present disclosure, an identifier can take the form of a radio frequency identification (RFID) tag that stores accessible data on a memory of the RFID tag. Such an RFID tag could be fixed on the saw blade.

The exemplary saw blade 30 can also include an identification sensor 90. The exemplary identification sensor 90 is directed at the exemplary saw blade 30 so that the exemplary identifier 88 passes through the field of detection of the exemplary identification sensor 90. The exemplary identification sensor 90 is configured to detect the identifier and transmit the detected identifier of the exemplary saw blade 30 to the exemplary controller 32. The exemplary identification sensor 90 can be a bar code scanner. In other embodiments, the identification sensor could be an RFID reader.

Before a cutting operation begins, the exemplary saw blade 30 can be moved into the detection field of the exemplary identification sensor 90 and rotated as necessary so the exemplary identifier 88 can be read/scanned by the exemplary identification sensor 90. The exemplary identification sensor 90 can transmit the detected bar code to the exemplary controller 32. As will be detailed below, the exemplary controller 32 can utilize the detected bar code to fetch data about the exemplary saw blade 30 and control the motors 16, 18, 20 based on the fetched data.

In an exemplary approach for operating the saw system 10, the workpiece 58 can be placed on and supported by the exemplary saw bed 34. The exemplary saw blade 30 of the exemplary cutter head assembly 12 can then be rotated by the pulleys 22, 28. Next, the exemplary cutter head assembly 12 can be moved relative to the exemplary saw bed 34 as the exemplary saw blade 30 rotates, to move the exemplary saw blade 30 into and through the workpiece 58. Throughout the cutting operation, the relative velocity between the exemplary saw bed 34 and the exemplary cutter head assembly 12 can be sensed with the radar sensor 36.

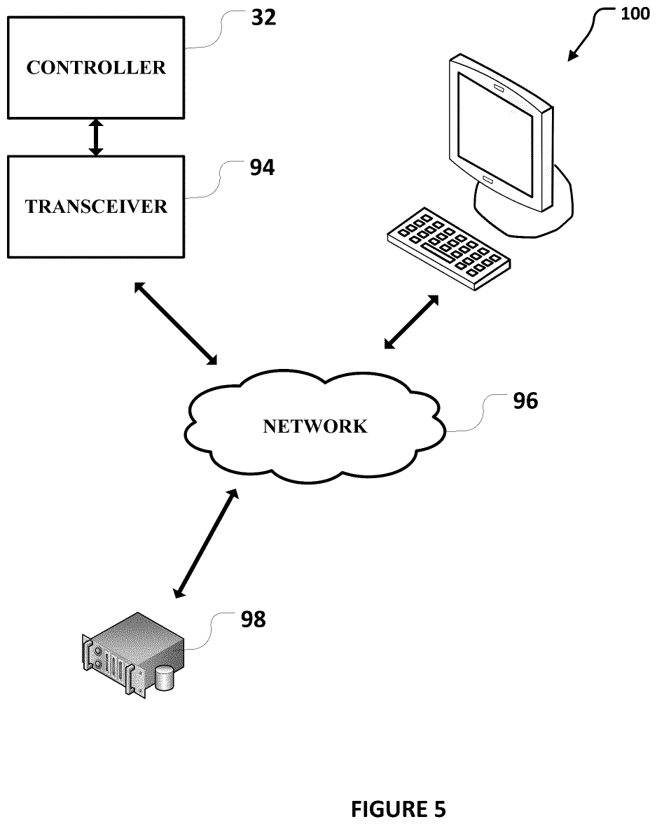

The saw system 10 can communicate with remote computing devices to, by way of example and not limitation, receive control commands, fetch data from storage, transmit alerts, transmit data for storage, and transmit an order for a replacement saw blade. Referring now to FIG. 5, the exemplary controller 32 of the system can include a transceiver 94 for communicating with other computing devices. The exemplary controller 32 can communicate through the exemplary transceiver 94 and over a network 96.

The exemplary network 96, that is illustrated schematically, can include a local area network (LAN), a wide area network (WAN), e.g., the Internet, a Multi-protocol label switching (MPLS) network, a cellular network such as operated by cellular phone companies, or any combination thereof. The exemplary network 96 can be practiced with a wireless network, a hard-wired network, or any combination thereof. The present disclosure is well suited to a wide variety of computer network systems over numerous topologies. Within this field, the configuration and management of large networks comprise storage devices and computers that are communicatively coupled to dissimilar computers and storage devices over a network.

In one example, the exemplary controller 32 can receive the detected identifier 88 (a bar code in this example) and transmit the data to a database 98 over the exemplary network 96. The exemplary database 98 can be a cloud server, accessible by mobile computing devices such as laptops and smartphones and also accessible by desktop computers. In response, the exemplary database 98 can retrieve data that is (i) stored in the exemplary database 98 and (ii) corresponds to the detected identifier 88 and thus also corresponds to the particular saw blade 30. The data stored in the exemplary database 98 can include, by way of example and not limitation, the usage history of the exemplary saw blade 30 and recommended usage parameters of the exemplary saw blade 30. The recommended usage/operating parameters can include a recommended number of remaining uses of the saw blade 30, a recommended blade linear speed (speed in a direction across the workpiece), and a recommended feed rate (speed in a direction into the workpiece). Recommended usage parameters can be dependent on the material being cut or can be constant and not dependent on the material being cut.

Further, the recommended operating parameters can be based on any prior usage. For example, if the saw blade 30 has not been previously used, the recommended operating parameters can correspond to a “breaking in” protocol in which the feed rate and/or linear speed of the saw blade is initially relatively low and then increased after a break-in period of use is completed.

The usage history of the exemplary saw blade 30 can include the number of cutting operations previously performed by the exemplary saw blade 30 and a recommended number of uses. The exemplary controller 32 can be configured to compare the number of cutting operations previously performed by the exemplary saw blade 30 against the recommended number of uses. In response to such a comparison, the exemplary controller 32 can be configured to transmit an alert that one or more additional saw blades should be acquired if the difference between the number of cutting operations previously performed and the recommended number of uses is less than a predetermined value, such as ten or five or one. An alert can be transmitted by the controller 32 over the network 96 to a computing device such as computing device 100. The exemplary computing device 100 can be a computing device used by the operator of the saw system 10.

The saw system 10 can include one or more user interface devices. A user interface device permits a human user to input data to the saw system 10. Examples of user interface devices include, but are not limited to, a touch display, a mouse, a keyboard, a microphone, and a camera. In the exemplary embodiment shown in FIG. 1, the saw system 10 includes a touch display or video monitor 102 having a display screen 104 and a keyboard 106 for the user/operator of the system 10 to enter data to the exemplary controller 32. The exemplary controller 32 can receive data associated with the workpiece 58 data through the user interface devices 102, 106, such as the material of the workpiece 58, the cross-sectional shape of the workpiece 58, and the size of the workpiece 58. The exemplary controller 32 can determine/select at least one parameter of the movement of the exemplary saw blade 30, such as linear speed and/or feed rate, in response to the recommend usage parameters and also in response to the parameters of the workpiece 58.

In the exemplary embodiment, the controller 32 is configured to transmit data to the exemplary database 98 after a cutting operation is completed so that the data stored for the saw blade 30 is updated. For example, the usage data stored in the exemplary database 98 can be updated with the additional cutting operation. Also, data such as cutting time and the amount of material removed during a cutting operation can be stored in the exemplary database 98 and can then be variables upon which future operating decisions are made.

As set forth above, the exemplary saw system 10 is configured such that the exemplary controller 32 receives data from the sensors 36, 68, 70, 74, 76, 84, 86, 90, 92, 206. It is noted that other embodiments of the present disclosure can include other sensors to monitor saw performance. Data transmitted between the exemplary controller 32 and any one of the exemplary sensors 36, 68, 70, 74, 76, 84, 86, 90, 92, 206 can be transmitted wirelessly or over wire. The respective data received from the sensors 36, 68, 70, 74, 76, 84, 86, 90, 92, 206 corresponds to the physical phenomena sensed by the respective sensors 36, 68, 70, 74, 76, 84, 86, 90, 92, 206. The exemplary saw system 10 is configured such that some or all of the data received from the respective sensors 36, 68, 70, 74, 76, 84, 86, 90, 92, 206 is displayed on the display screen 104 of the touch screen video monitor 102. This allows the operator of the saw system 10 to monitor the various attributes of the cutting operation that are sensed by the sensors 36, 68, 70, 74, 76, 84, 86, 90, 92, 206.

In addition, the exemplary controller 32 is configured to change an operating parameter in response to data received from any of the respective sensors 36, 68, 70, 74, 76, 84, 86, 90, 92, 206. Further, the exemplary controller 32 is configured to display on the video monitor 102 any changes to be made in any of the operating parameters based on the programming of the exemplary controller 32. The exemplary controller 32 can also be configured to control the video monitor 102 to display buttons that the operator can use to approve a change proposed or recommended by the exemplary controller 32, or to make a user-desired change to an operation parameter. Thus, in one or more embodiments of the present disclosure, the system 10 can operate such that the exemplary controller 32 merely presents proposed changes in operation to the human operator, which the human operator can choose to implement or choose to reject. Such proposed changes can be presented through the display screen 104, for example. In one or more embodiments of the present disclosure, the exemplary controller 32 can also be configured to control the video monitor 102 to display a button that the operator can select to order a new saw blade.

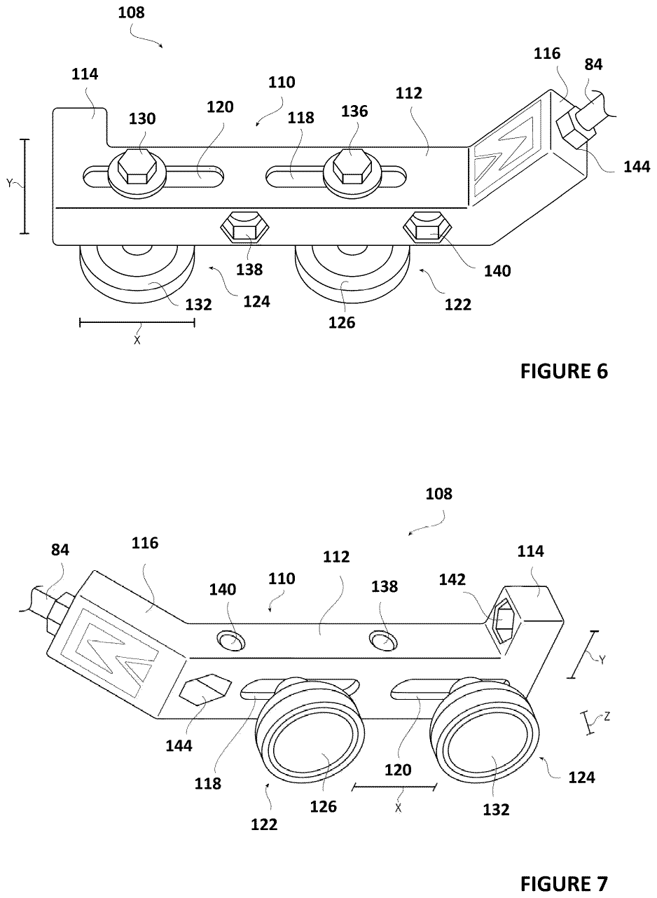

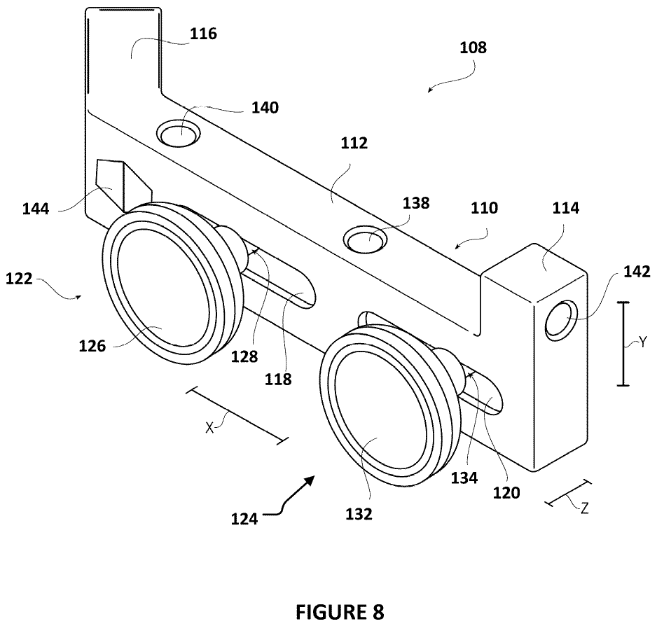

In various embodiments of the present disclosure, the exemplary sensor 84 can be mounted to the exemplary cutter head assembly 12 with a magnetic mount 108 shown in FIGS. 6-8 and thus be non-invasive to the cutter head assembly 12 or the saw bed 34. The exemplary magnetic mount 108 includes a main body 110. The exemplary main body 110 has a central portion 112, a first end portion 114, and a second end portion 116. The exemplary main body 110 may be formed from metal or metal alloy or plastic or resin material. The exemplary main body 110 may be monolithically formed as a unitary body or may be formed in separate discrete pieces that are joined together, for example, by welding, chemical boding, adhesion, or fusion. The exemplary main body 110 defines a longitudinal axis X and a transverse axis Y. The longitudinal and transverse axes X and Y define a plane. The exemplary central portion 112 extends in the plane defined by the longitudinal and transverse axes X and Y.

The exemplary magnetic mount 108 also includes two slots 118, 120 formed in the exemplary central portion 112. The exemplary slots 118, 120 have a length extending in the X-Y plane, a width extending in the X-Y plane, and a depth in the Y-Z plane. In the illustrated embodiment the exemplary slots 118, 120 are each parallel to the longitudinal axis X and linearly aligned with each other, but such is not required in all embodiments of the present disclosure. Further, the exemplary central portion 112 may have more than two slots 118, 120 in one or more other embodiments of the present disclosure.

The exemplary magnetic mount 108 also includes a magnetic foot assembly received in each of the slots 118, 120. An exemplary magnetic foot assembly 122 is received in the exemplary slot 118 and an exemplary magnetic foot assembly 124 is received in the exemplary slot 120. The exemplary magnetic foot assembly 122 includes a magnetic foot 126, a shaft 128 fixed to the magnetic foot 126 and extending through the exemplary slot 118, and a retainer 130 fixed to an end of the shaft 128 opposite the magnetic foot 126. The exemplary retainer 130 is a bolt head. As shown, a washer can be positioned between the retainer 130 and the exemplary central portion 112. The shaft 128 can be threadingly engaged with the magnetic foot 126, so that turning the exemplary retainer 130 causes the exemplary central portion 112 to be compressed between the retainer 130 and the magnetic foot 126 and also causes the magnetic foot 126 to be held in a desired position within the slot 118. It is noted that a nut (not shown) can be threadingly engaged with the shaft 128 between the exemplary central portion 112 and the magnetic foot 126 so that a distance between the magnetic foot 126 and the exemplary central portion 112 along the Z axis is adjustable. The exemplary magnetic foot assembly 124 is constructed identically to exemplary magnetic foot assembly 122 and includes a magnetic foot 132, a shaft 134, and a retainer 136.

The exemplary central portion 112 includes passageways 138, 140 that extend parallel to each other and to the Y axis. The exemplary first end portion 114 includes a passageway 142 that extends parallel to the X axis. The second end portion 116 includes a passageway 144 that extends transverse to all three reference axes X, Y, and Z. The exemplary passageways 138, 140, 142, 144 are through apertures, in contrast to blind apertures, and are configured to receive other structures, such as posts.

In operation, the magnetic feet 126, 132 can be placed on a ferric portion of the frame 14 or saw bed 34 to fix the magnetic mount 108 to the frame 14 or to the saw bed 34. Then, a shaft portion of the exemplary sensor 84 can be inserted in one or more of the exemplary passageways 138, 140, 142, 144 to fix that sensor to the frame 14 or to the saw bed 34. In FIGS. 6-7, a portion of the sensor 84 is shown received in the passageway 144. It is noted that one or more of the exemplary passageways 138, 140, 142, 144 can have a circular cross-section to permit rotation of the sensor. Alternatively, the cross-section of the passageway and the portion of the sensor that is received in that passageway can be non-circular so that rotation of the sensor relative to the magnetic mount 108 is prevented.

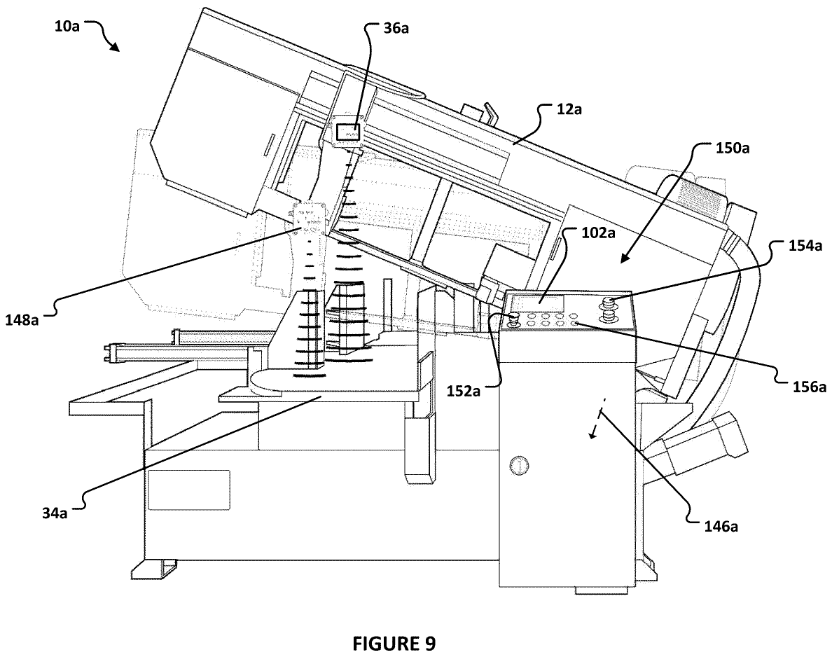

Referring now to FIG. 9, in another embodiment of the present disclosure, a saw system 10a includes a cutter head assembly 12a and a saw bed 34a. In the exemplary saw system 10a, the exemplary cutter head assembly 12a pivots about a pivot axis 146a relative to the saw bed 34a. FIG. 9 shows the cutter head assembly 12a in a first position in regular line and in a second position, pivoted from the first position, in phantom. The exemplary saw bed 34a is stationary during the pivoting movement of the exemplary cutter head assembly 12a.

FIG. 9 shows that in the second embodiment the saw system 10a includes a radar sensor. The radar sensor is referenced by 36a when the cutter head assembly 12a is in the first position and by 148a when the cutter head assembly 12a is in the second position. FIG. 9 shows that exemplary radar sensor 36a includes a display that shows the sensed relative velocity between the exemplary saw bed 34a and the exemplary cutter head assembly 12a. FIG. 9 also shows that exemplary radar sensor is pivotally mounted on the exemplary cutter head assembly 12a and permitted to freely rotate in response to gravity so that the exemplary radar sensor is directed at the exemplary saw bed 34a throughout pivoting movement the exemplary cutter head assembly 12a.

FIG. 9 also shows that in the second embodiment the saw system 10a includes a control panel 150a in which is a video display 102a and a plurality of user interface devices are mounted. The exemplary user interface devices include a joystick 152a, a rotatable knob 154a, and buttons such as button 156a. The operator of the system 10a can input data to a controller of the system 10a to change or approve proposed operating parameters.

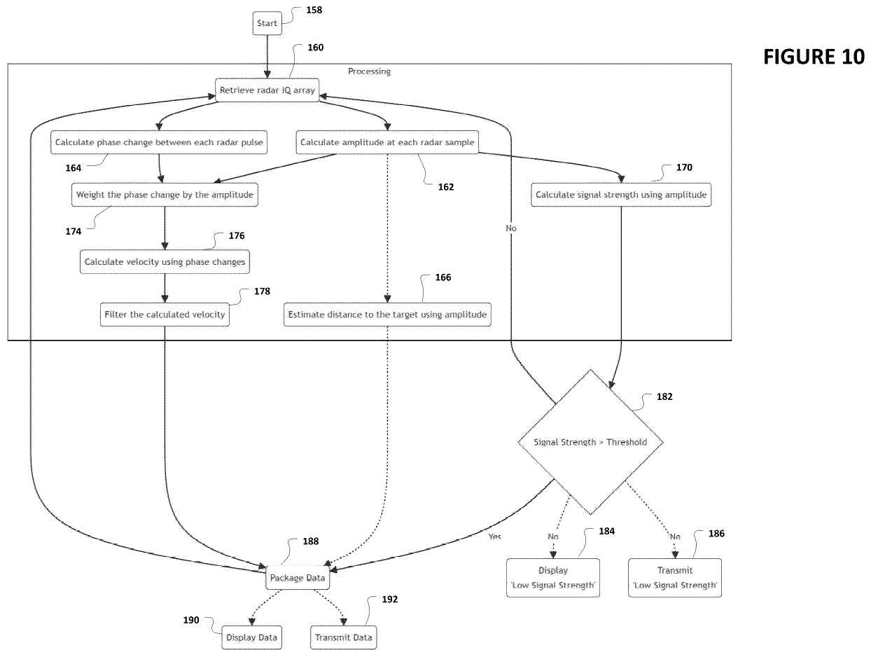

FIG. 10 is a simplified flow diagram of radar processing in one or more embodiments of the present disclosure. Dotted pathways represent optional logical paths. The process represented by FIG. 10 is performed by the exemplary radar sensor 36 and starts at 158. At 160, the exemplary radar sensor 36 receives radar data through a radar IQ array. The data can be in the format of a plurality of radar samples, each sample being a distinct radar detection. It is noted that each radar sample of detection is associated with a distinct radar wave signal associated with an electromagnetic wave deflected off of a first structure electromagnetic waves deflected off of the same structure, in the exemplary embodiment the saw bed 34 deflects the radar waves.

The radar sample array at time t is represented as:

$${R}_{t} = [ \begin{matrix}{a}_{1 , t} + {b}_{1 , t} i & {a}_{2 , t} + {b}_{2 , t} i & {a}_{3 , t} + {b}_{3 , t} i & … & {a}_{n , t} + {b}_{n , t} i\end{matrix} ]$$

Each element in Rₜ corresponds the received signal's amplitude and phase at progressively increasing time intervals following the radar signal emission. Given the relatively constant velocity of radio waves, the distance traveled by a reflected wave can be inferred at each array element.

The process continues from 160 to 162 and 164. At 162, the exemplary radar sensor 36 calculates the amplitude of the wave signal of each radar sample. The average amplitude can also be calculated with the following equation, where r_{i,t}=a_{i,t}+b_{i,t}i:

$$‖ \overline{{R}_{t}} ‖ = \frac{1}{n} {\sum }_{i = 1}^{n} \vert {r}_{i , t} \vert$$

At 164, the exemplary radar sensor 36 calculates the phase change between the wave signal of each radar sample/pulse. Generally, the phase change is between the phase of the present, distinct radar wave signal that is being assessed and the phase of the distinct radar wave signal that was immediately previous assessed; in other words, the last distinct radar wave signal that was assessed. The phase change at each point can be determined by calculating the argument of the product of the current array Rₜ and the complex conjugate of the previous array Rₜ₋₁ with the following equation:

$$Δ {θ}_{t} = arg ( {R}_{t} * \overline{{R}_{t - 1}} )$$

Following 162, a first subroutine continues to 166 and the exemplary radar sensor 36 estimates the distance between the exemplary cutter head assembly 12 and the exemplary saw bed 34 based on the calculated amplitude. The process continues from 166 to 188, which will be described in greater detail below. Also following 162, a second subroutine continues to 170 and the exemplary radar sensor 36 calculates the signal strength of the wave signal of each radar sample based on the amplitude of the received signals.

Following 164, a third subroutine continues to 174 and the exemplary radar sensor 36 weights the phase change by the amplitude calculated at 162. The following equation can be used to compute the average phase change weighted by the signal strength at each element:

$$d {ϑ}_{t} = \frac{\sum ( Δθ * \vert {R}_{t} \vert )}{\sum \vert {R}_{t} \vert}$$

After 174 at 176, the exemplary radar sensor 36 calculates a velocity using the phase changes weighted at 174. It is noted that the calculated velocity is the velocity of the exemplary cutter head assembly 12 toward the exemplary saw bed 34. The following equation can be utilized to calculate the velocity vₜ using the radar wavelength λ and the sample frequency f:

$${v}_{t} = \frac{d {ϑ}_{t} f λ}{2 π}$$

After 176 at 178, the exemplary radar sensor 36 filters the calculated velocity. The calculated velocity is filtered using a one dimensional Kalman filter. The Kalman filter smooths variations in the sampled velocity due to noise. The process continues from 178 to 188, which will be described in greater detail below.

The process continues from 170 to 182, where the exemplary radar sensor 36 compares the calculated signal strength with a threshold value for signal strength. The threshold value can be predetermined and stored in the memory of the exemplary radar sensor 36. If the calculated signal strength is not greater than the threshold value, the exemplary radar sensor 36 can control the video monitor 102 to display a message indicating low signal strength at 184 and can also transmit the message at 186 to the controller 32. Velocity does not play a role in the decision. Also, if the calculated signal strength is not greater than the threshold value, the logic applied by the exemplary radar sensor 36 returns to 160. If the calculated signal strength is greater than the threshold value at 182, the process can continue to 188.

At 188, the calculated, filtered velocity and the estimated distance are packaged together with confirmation that the signal strength was above the threshold. After 188 at 190, the exemplary radar sensor 36 transmits the calculated, filtered velocity and the estimated distance to be displayed to the operator and, at 192, transmits the data to the controller 32. Also, after 188, the logic applied by the exemplary radar sensor 36 returns to 160.

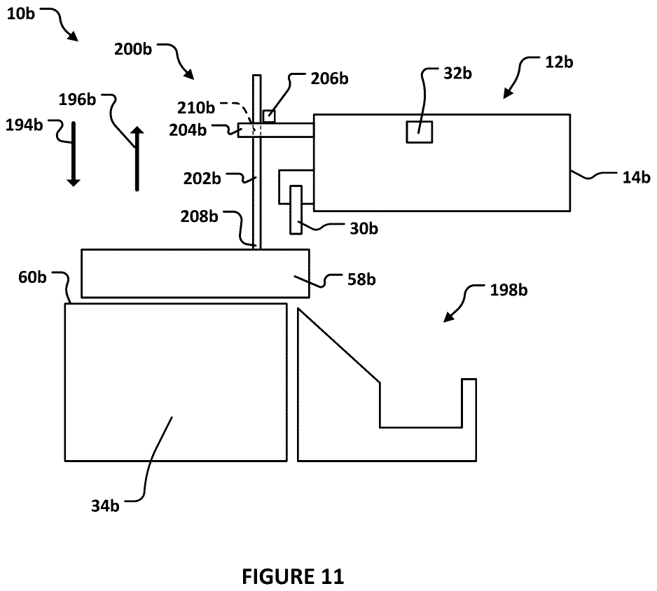

FIG. 11 is a schematic front view of a saw system according to another embodiment of the present disclosure. An exemplary saw system 10b includes a cutter head assembly 12b with, by way of example and not limitation, a frame 14b, a saw blade 30b supported on the frame 14b for rotation to cut a workpiece 58b, and a controller 32b. The exemplary saw system 10b also includes a saw bed 34b having a workpiece supporting surface 60b. The exemplary saw system 10b also includes appropriate motors and guide tracks, examples of which have been described above, whereby the exemplary cutter head assembly 12b can move in a direction referenced at 194b while the saw blade 30b is rotating to cut into a workpiece 58b. A portion of the workpiece 58b that is cut away from a remainder of the workpiece 58b can be collected in a bin, such as the bin shown schematically and referenced at 198b. The exemplary cutter head assembly 12b can also move in a direction referenced at 196b to move the saw blade 30b away from the workpiece 58b and the surface 60b.

The exemplary saw system 10b also includes a cut depth sensor assembly 200b. The exemplary cut depth sensor assembly 200b includes a rod 202b, a collar 204b, and a movement sensor 206b. The exemplary rod 202b includes a first end 208b configured to rest on the workpiece 58b during the cutting operation. The exemplary collar 204b is fixedly positioned relative to the exemplary cutter head assembly 12 and includes an aperture 210b. The exemplary rod 202b is received in the aperture 210b and moves in the aperture 210b as the exemplary cutter head assembly 12b moves relative to the exemplary saw bed 34b during the cutting operation, in the direction 194b or the direction 196b.

The exemplary movement sensor 206b is fixedly positioned relative to the exemplary cutter head assembly 12. The exemplary movement sensor 206b is positioned to sense movement of the exemplary rod 202b relative to exemplary collar 204b. For example, the exemplary rod 202b may include markings such as indicia or physical features such as notches that the exemplary movement sensor 206b can detect. In such embodiments, the exemplary movement sensor 206b can be configured to count the number of sensed markings/notches that are detected as the exemplary rod 202b moves and convert the count to a distance. Other approaches to sensing and quantifying movement can be applied in other embodiments of the present disclosure.

The exemplary movement sensor 206b is configured to transmit signals corresponding to sensed conditions to the exemplary controller 32b. The exemplary controller 32b can control operations of the drive motors of the exemplary cutter head assembly 12b in response to signals received from the exemplary movement sensor 206b. For example, the exemplary controller 32b can slow or stop the operation of the drive motors if the cut detection data indicates that the workpiece 58b is not being cut, despite signals from other sensors that may indicate otherwise.

What has been described above includes examples of the subject innovation. It is, of course, not possible to describe every conceivable combination of components or methodologies for purposes of describing the disclosed subject matter, but many further combinations and permutations of the subject innovation are possible. The use of any and all examples, or exemplary language (e.g., “such as”) provided herein is intended merely to be illustrative and does not pose a limitation on the scope of any innovation disclosed herein unless otherwise claimed. The word “exemplary” is used to mean serving as an example, instance, or illustration. Any aspect or design described herein as “exemplary” is not necessarily to be construed as preferred or advantageous over other aspects or designs. Rather, use of the word “exemplary” is intended to present concepts in a concrete fashion. Further, any statements set forth within the Detailed Description of this document and addressing a prior art device(s) are the observations of the inventors and such statements themselves are not prior art or admissions as to what is prior art.

As used herein, the singular forms “a,” “an,” and “the” include plural referents unless the context clearly dictates otherwise. Unless indicated otherwise by context, the term “or” is to be understood as an inclusive “or.” Terms such as “first”, “second”, “third”, etc. when used to describe multiple devices or elements, are so used only to convey the relative actions, positioning and/or functions of the separate devices, and do not necessitate either a specific order for such devices or elements, or any specific quantity or ranking of such devices or elements. Use of the terms “about” or “approximately” are intended to cover values that are above and/or below a stated value or range, or within manufacturing tolerances, as would be understood by one having ordinary skill in the art in the respective context. In some instances, this may encompass values in a range of approx. +/−10%; in other instances there may be encompassed values in a range of approx. +/−5%; in yet other instances values in a range of approx. +/−2% may be encompassed; and in yet further instances, this may encompass values in a range of approx. +/−1%.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof, unless indicated herein or otherwise clearly contradicted by context. Recitations of a value range herein, unless indicated otherwise, serves as a shorthand for referring individually to each separate value falling within the stated range, including the endpoints of the range, each separate value within the range, and all intermediate ranges subsumed by the overall range, with each incorporated into the specification as if individually recited herein. Unless indicated otherwise, or clearly contradicted by context, methods described herein can be performed with the individual steps executed in any suitable order, including: the precise order disclosed, without any intermediate steps or with one or more further steps interposed between the disclosed steps; with the disclosed steps performed in an order other than the exact order disclosed; with one or more steps performed simultaneously; and with one or more disclosed steps omitted, unless expressly contradicted by the text herein or context.

While the present disclosure has been described with reference to one or more exemplary embodiments, it is to be understood that various changes may be made, and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure is not limited to a particular embodiment disclosed herein as the best mode contemplated for carrying out this present disclosure, but that the present disclosure will be viewed as covering any embodiment falling within the scope of the appended claims. Various aspects or features described herein may be implemented as a method, apparatus, or article of manufacture using standard programming and/or engineering techniques.

Also, the right to claim for patent coverage a particular sub-feature, a sub-component, or a sub-element of any disclosed embodiment, singularly or in one or more sub-combinations with any other sub-feature(s), sub-component(s), or sub-element(s), is hereby unconditionally reserved by the Applicant. Also, particular sub-feature(s), sub-component(s), and sub-element(s) of one embodiment that is disclosed herein can replace particular sub-features, sub-components, and sub-elements of another embodiment disclosed herein or can supplement and be added to another embodiment unless expressly indicated otherwise by the drawings or this specification. The inventors also assert that any of the claims set forth after this detailed description can be combined with any other claim or claims regardless of whether or not there is a direct line of dependency, unless there is an express indication in this text or the drawings unambiguously indicating that such a combination is not possible. For example, the radar sensor, its configuration and operation, can be the subject of its own patent. The order of the claims and the lines of dependency are irrelevant to the various ways that the features, elements, sub-elements, components, sub-components, etc. of the present disclosure can be combined and thus claimed. Further, the doctrine of claim differentiation is to be applied in construing the appended claims. Further, the use of the word “can” in this document is not an assertion that the subject preceding the word “can” is unimportant or unnecessary or “not critical” relative to anything else in this document. The word “can” is used herein in a positive and affirming sense and no other motive should be presumed. More than one patentable “invention” may be disclosed in the present disclosure, and it is noted that an “invention” is defined by the content of a patent claim and not by the content of descriptive text or drawings.

What is claimed is:

1. A saw system comprising:
a cutter head assembly having:
a frame,
at least one drive motor mounted on the frame,
a first pulley mounted for rotation on the frame and operably engaged with said at least one drive motor whereby said first pulley is driven in rotation by said at least one drive motor,
at least one rotary driver mounted for rotation on the frame and operably engaged with said at least one drive motor whereby said rotary driver is driven in rotation by said at least one drive motor,
a second pulley mounted for rotation on the frame and spaced from said first pulley,
a saw blade extending around said first pulley and said second pulley, and
a controller configured to control operations of said at least one drive motor;
a saw bed configured to support a workpiece to be cut during a cutting operation performed by said cutter head assembly;
at least one radar sensor mounted to one of said cutter head assembly and said saw bed, configured to emit radio waves in a direction toward the other of said cutter head assembly and said saw bed, and configured to receive radio waves previously emitted by said at least one radar sensor and deflected by the other of said cutter head assembly and said saw bed, and configured to one of:
(i) determine a relative velocity between said cutter head assembly and said saw bed based on received radio waves and transmit the relative velocity to said controller, and
(ii) transmit raw data associated with received radio waves to said controller; and
wherein said controller is further defined as configured to control operations of said at least one drive motor in response to the one of the relative velocity and the raw data received from said at least one radar sensor.

2. The saw system of claim 1 wherein said at least one radar sensor is further defined as pivotally mounted on said cutter head assembly and freely pivotably in response to gravity.

3. The saw system of claim 1 wherein said at least one radar sensor is further defined as mounted to said frame with one or more magnets and configured to communicate with said controller wirelessly.

4. The saw system of claim 1 further comprising:
a blade velocity sensor directed at said saw blade and configured to detect a velocity of said saw blade and transmit the detected velocity of said saw blade to said controller;
a pulley angular speed sensor directed at one of said first pulley and said second pulley, said pulley angular speed sensor configured to detect an angular speed of said one of said first pulley and said second pulley and transmit the detected angular speed of said one of said first pulley and said second pulley to said controller; and
wherein said controller is configured to determine a consistency between the detected velocity of said saw blade and the detected angular speed of said one of said first pulley and said second pulley.

5. The saw system of claim 1 further comprising:
a band proximity sensor directed at said saw blade and configured to detect proximity of said saw blade and transmit the detected proximity of said saw blade to said controller.

6. The saw system of claim 1 further comprising:
at least one guide arm supporting said saw blade; and
a vibration sensor directed at said at least one guide arm and configured to detect vibration of said at least one guide arm and transmit the detected vibration to said controller.

7. The saw system of claim 1 further comprising:
a chip brush assembly mounted on said frame and positioned adjacent to said saw blade, said chip brush assembly having a shaft and a brush mounted on said shaft, wherein said shaft rotates as said brush engages said saw blade as said saw blade moves during the cutting operation; and
a rotation sensor operably engaged with said shaft of said chip brush assembly and configured to detect rotation of said shaft of said chip brush assembly and transmit the detected rotation of said shaft of said chip brush assembly to said controller.

8. The saw system of claim 1 further comprising:
a current sensor disposed to sense current passing through at least part of said at least one drive motor and transmit a level of the current to said controller.

9. The saw system of claim 1 wherein:
said saw blade further comprises an identifier; and
said system further comprises an identification sensor directed at said saw blade and configured to said identifier and transmit the detected identifier of said saw blade to said controller.

10. The saw system of claim 1 further comprising:
a cut depth sensor assembly including a rod, a collar, and a movement sensor, wherein said rod includes a first end configured to rest on the workpiece during the cutting operation, wherein said collar is fixedly positioned relative to said cutter head assembly and includes an aperture, wherein said rod is received in said aperture and moves in said aperture as said cutter head assembly moves relative to said saw bed during the cutting operation, and wherein said movement sensor is fixedly positioned relative to said cutter head assembly and positioned to sense movement of said rod relative to collar and transmit signals corresponding to sensed conditions to said controller.

11. The saw system of claim 1 further comprising:
at least one track on which said frame is mounted for movement; and
at least one cutter head drive sensor configured to sense an extent of the movement of said frame relative to said at least one track and transmit signals corresponding to sensed conditions to said controller.

12. A method of cutting a workpiece comprising:
supporting a workpiece on a saw bed;
rotating a band saw blade of a cutter head assembly;
moving one of the cutter head assembly and the saw bed relative to the other during said rotating and said supporting whereby the band saw blade is directed through the workpiece; and
monitoring a relative velocity between a portion of said saw bed and a portion of said cutter head assembly during said moving with radar.

13. The saw system of claim 1 wherein said moving is further defined as:
pivoting the cutter head assembly about a pivot axis, wherein the saw bed is stationary during said moving.

14. The saw system of claim 1 further comprising:
reading, with an identification reader, identification data associated with the band saw blade wherein the data is fixedly associated with the band saw blade.

15. The saw system of claim 14 further comprising:
fetching, with a controller, specification data associated with the band saw blade from a database in response to the identification data read during said reading.

16. The saw system of claim 15 further comprising:
receiving, with the controller, workpiece data being at least one of material, cross-sectional shape, and size of the workpiece; and
determining, with the controller, at least one parameter of movement during said rotating and said moving in response to the specification data and the workpiece data.

17. The saw system of claim 15 further comprising:
updating, with the controller, usage data associated with the band saw blade stored in the database after said moving.

18. The saw system of claim 12 further comprising:
sensing at least one parameter of movement during said rotating and said moving with a sensor;
transmitting, with the sensor, sensed data associated with the at least one parameter of movement to a controller; and
displaying, on a video monitor screen controlled by the controller, the transmitted data associated with the at least one parameter.

19. The saw system of claim 18 wherein said transmitting is further defined as:
transmitting wirelessly, with the sensor, sensed data associated with the at least one parameter of movement to the controller.

20. The saw system of claim 18 further comprising:
determining, with the controller, in response to the transmitted data associated with the at least one parameter, a change in the at least one parameter of movement; and
displaying, on a video monitor screen controlled by the controller, the change in the at least one parameter.

21. The saw system of claim 1 wherein the least one radar sensor is further defined as configured to:
receive data in the format of a plurality of radar samples, each sample of the plurality of radar samples being a distinct radar wave signal associated with an electromagnetic wave deflected off of a first structure;
calculate an amplitude of a present distinct radar wave signal;
calculate a phase change between the present distinct radar wave signal and the immediately previous distinct radar wave signal;
determine a weighted average phase change in the form of the average of the phase changes of received distinct radar wave signals weighted by a signal strength of the present distinct radar wave signal;
calculate a velocity of the first structure based at least in part on the weighted average phase change; and
filter the calculated velocity using a one dimensional Kalman filter.

22. A method of calculating a velocity using a radar signal comprising:
receiving, with a radar IQ array of a radar sensor, data in the format of a plurality of radar samples, each sample of the plurality of radar samples being a distinct radar wave signal associated with an electromagnetic wave deflected off of a first structure;
calculating, with the radar sensor, an amplitude of a present distinct radar wave signal;
calculating, with the radar sensor, a phase change between the present distinct radar wave signal and the immediately previous distinct radar wave signal;
determining, with the radar sensor, a weighted average phase change in the form of the average of the phase changes of received distinct radar wave signals weighted by a signal strength of the present distinct radar wave signal;
calculating, with the radar sensor, a velocity of the first structure based at least in part on the weighted average phase change; and
filtering, with the radar sensor, the calculated velocity using a one dimensional Kalman filter.
